(19) United States
(12) Patent Application Publication
(10) Pub. No.: US 2020/0137473 A1
(43) Pub. Date: Apr. 30, 2020

(54) MICROPHONE

(71) Applicant: YAMAHA CORPORATION, Hamamatsu-shi (JP)

(72) Inventors: Yu TSUCHIHASHI, Hamamatsu-shi (JP); Satoshi GOUGI, Hamamatsu-shi (JP); Atsushi HATTORI, Yasu-shi (JP); Kazuhiko NISHIZAWA, Hamamatsu-shi (JP)

(21) Appl. No.: 16/665,380

(22) Filed: Oct. 28, 2019

(30) Foreign Application Priority Data
Oct. 31, 2018 (JP) 2018-205398

(51) Int. Cl. H04R 1/04; H04R 9/08

(52) U.S. Cl. CPC H04R 1/04; H04R 9/08

(57) ABSTRACT

A microphone includes: a housing; a microphone unit that outputs a sound signal disposed in the housing; an elastic member mounted to the microphone unit; and a weight member mounted to the elastic member.

### CROSS REFERENCE TO RELATED APPLICATION

The present application claims priority from Japanese Patent Application No. 2018-205398, which was filed on Oct. 31, 2018, the disclosure of which is herein incorporated by reference in its entirety.

### BACKGROUND

The following disclosure relates to a microphone.

Microphones may generate noise if vibrations are caused due to an external force and transmitted to a microphone unit which converts between a sound and an electric signal (hereinafter may be referred to as “sound signal”) representing a waveform of the sound. One example of the noise is handling noise caused in a handheld microphone. The handling noise is generated when vibrations are transmitted from a hand holding the microphone to a housing of the microphone and then to the microphone unit supported in the housing, and thereby a sound signal containing a vibration component is output.

To reduce the handling noise, a structure for supporting the microphone unit with respect to the housing has been proposed. In this structure, an insulator formed of an elastic material such as rubber is interposed between the microphone unit and the housing. For example, Patent Document 1 (Japanese Patent No. 5595143) discloses a structure for elastically supporting a microphone unit 30 by using a damper 20 containing electrorheological fluid 27. In a microphone disclosed in Patent Document 1, when an impact is given to a body of the microphone, a piezoelectric element 40 is deformed to generate electric power, and the electrorheological fluid 27 is given a voltage and hardened. This reduces excessive displacement of the microphone unit 30.

In order to prevent a resonance peak in a low-order vibrating mode from appearing in an audible frequency range between 20 Hz and 20 kHz, various techniques for shifting the resonance peak to a frequency lower than the lower limit in the audible frequency range have been proposed. One example of the techniques is to make the microphone unit heavier or reduce a force by which the insulator supports the microphone unit.

### SUMMARY

Even if the technique disclosed in Patent Document 1 is employed, an impact applied to the body of the microphone still causes a resonance of the microphone unit, and a peak related to a frequency of this resonance still remains in a signal output from the microphone unit. Also, making the microphone unit heavier or reducing the force by which the insulator supports the microphone unit may lower performance of holding the microphone unit, making it impossible to ensure the quality of the microphone.

Accordingly, an aspect of the disclosure relates to a microphone capable of reducing handling noise while ensuring the quality of the microphone.

In one aspect of the disclosure, a microphone includes: a housing; a microphone unit that outputs a sound signal disposed in the housing; an elastic member mounted to the microphone unit; and a weight member mounted to the elastic member.

### BRIEF DESCRIPTION OF THE DRAWINGS

The objects, features, advantages, and technical and industrial significance of the present disclosure will be better understood by reading the following detailed description of the embodiment, when considered in connection with the accompanying drawings, in which:

FIG. 1 is a partial cross-sectional view of a microphone according to one embodiment;

FIG. 2 is an exploded perspective view of a dynamic vibration absorber of the microphone;

FIG. 3 is a view for explaining effects of the present embodiment;

FIG. 4 is a partial cross-sectional view of a microphone according to a third modification;

FIG. 5 is a partial cross-sectional view of a microphone according to one example of a fourth modification;

FIG. 6 is a perspective view of the microphone according to another example of the fourth modification;

FIG. 7 is a partial cross-sectional view of a microphone according to one example of a fifth modification;

FIG. 8 is a partial cross-sectional view of the microphone according to another example of the fifth modification;

FIG. 9 is a partial cross-sectional view of a microphone according to one example of a sixth modification;

FIG. 10 is a partial cross-sectional view of a microphone according to another example of the sixth modification; and

FIG. 11 is a partial cross-sectional view of a microphone according to yet another example of the sixth modification.

### EMBODIMENT

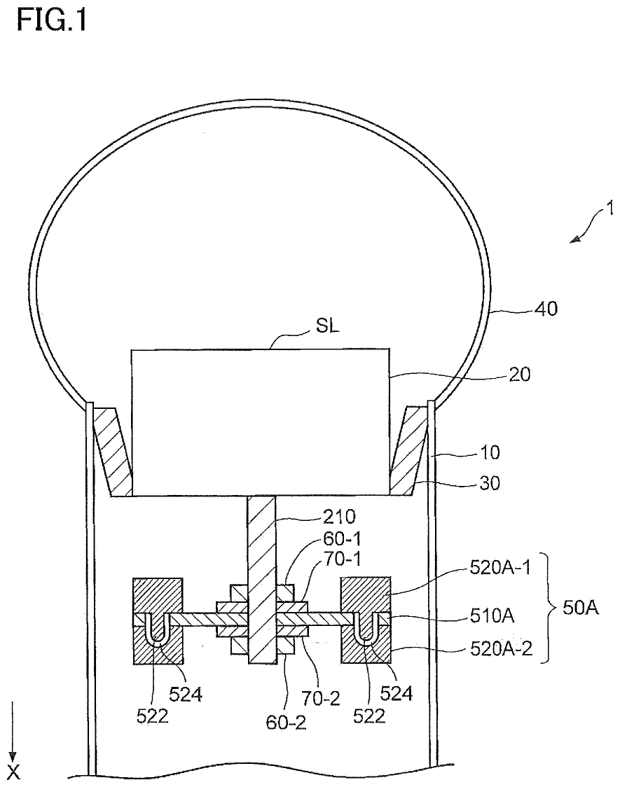

Hereinafter, there will be described one embodiment by reference to the drawings. FIG. 1 is a partial cross-sectional view of a microphone 1 according to one embodiment. The microphone 1 is a handheld microphone having a substantially cylindrical shape. FIG. 1 is a cross-sectional view of a head portion of the microphone 1, taken along a plane including the central axis of the microphone 1 (i.e., the central axis of the cylindrical shape). As illustrated in FIG. 1, the microphone 1 includes: a housing 10; a microphone unit 20; an insulator 30 that supports the microphone unit 20 with respect to the housing 10; a windshield 40 that covers the microphone unit 20; and a dynamic vibration absorber 50A mounted to the microphone unit 20.

The housing 10 is a cylindrical member formed of resin or metal. When using the microphone 1, a user holds the housing 10 such that the windshield 40 faces vertically upward. The windshield 40 is configured to protect the microphone unit 20 and formed of metal mesh, for example. The windshield 40 allows sounds having arrived from the outside to pass through the windshield 40 to an inner space defined by the windshield 40 and the housing 10. As illustrated in FIG. 1, the microphone unit 20 is supported by the insulator 30 in this inner space.

The microphone unit 20 is a substantially cylindrical member having a diameter that is less than that of the housing 10. The microphone unit 20 includes: a diaphragm formed of synthetic resin or metal; and an electroacoustic transducer configured to convert vibrations of the diaphragm which are caused by sounds having arrived from the outside, to sound signals and output these sound signals. FIG. 1 omits illustration of the diaphragm and the electroacoustic transducer. The configuration of the electroacoustic transducer may be that of an electroacoustic transducer in conventional microphone units. Specifically, the electroacoustic transducer includes: a voice coil connected to the diaphragm; and magnets and a yoke which generate a magnetic field interlinked with the voice coil.

The insulator 30 is a cylindrical member having an inverted conical trapezoid shape and formed of an elastic material such as fluororubber. The insulator 30 has opposite end faces orthogonal to the central axis of the insulator 30 (i.e., the rotation axis of the inverted conical trapezoid shape). In the following description, one of the end faces which has a radius less than that of the other of the end faces may be referred to as “first end face”, and the other may be referred to as “second end face”.

When using the microphone 1 according to the present embodiment, the user holds the housing 10 such that the windshield 40 faces vertically upward. In this state, the insulator 30 is mounted to the housing 10 such that the first end face faces vertically downward (the direction indicated by arrow X in FIG. 1), that is, the insulator 30 is mounted to the housing 10 such that the first end face that is one of the end faces of the insulator 30 which has a radius less than that of the other is located below the second end face that is the other of the end faces of the insulator 30 which has the radius greater than that of the one of the end faces. The inside diameter of the first end face of the insulator 30 is substantially equal to the outside diameter of the microphone unit 20. An inner circumferential portion of the first end face is in contact with the microphone unit 20 to support the microphone unit 20. The outside diameter of the second end face of the insulator 30 is substantially equal to the inside diameter of the housing 10. An outer circumferential portion of the second end face is in contact with the housing 10. The outer circumferential portion of the second end face is in contact with an inner circumferential surface of the housing 10 to support the insulator 30 with respect to the housing 10.

A screw 210 extending vertically downward is provided on a bottom surface of the microphone unit 20. The dynamic vibration absorber 50A is mounted on the screw 210. The dynamic vibration absorber 50A includes an elastic member 510A and weight members 520A-1, 520A-2 mounted on the elastic member 510A. In the dynamic vibration absorber 50A, what is called a spring-mass system is formed by the elasticity of the elastic member 510A and the mass of the weight members 520A-1, 520A-2. In the present embodiment, a resonance of the spring-mass system reduces vibrations of the microphone unit 20 vertically in the up and down direction. More specifically, when vibrations are transmitted from a hand of the user holding the microphone 1 to the housing 10, and vibrations vertically in the up and down direction are caused on the microphone unit 20 supported in the housing 10, the elastic member 510A (more precisely, a coupling member 514 which will be described below) vibrates, and the weight members 520A-1, 520A-2 vibrate at a phase reverse to that of the microphone unit 20. The vibrations of the weight members 520A-1, 520A-2 at the reverse phase reduce vibrations of the microphone unit 20.

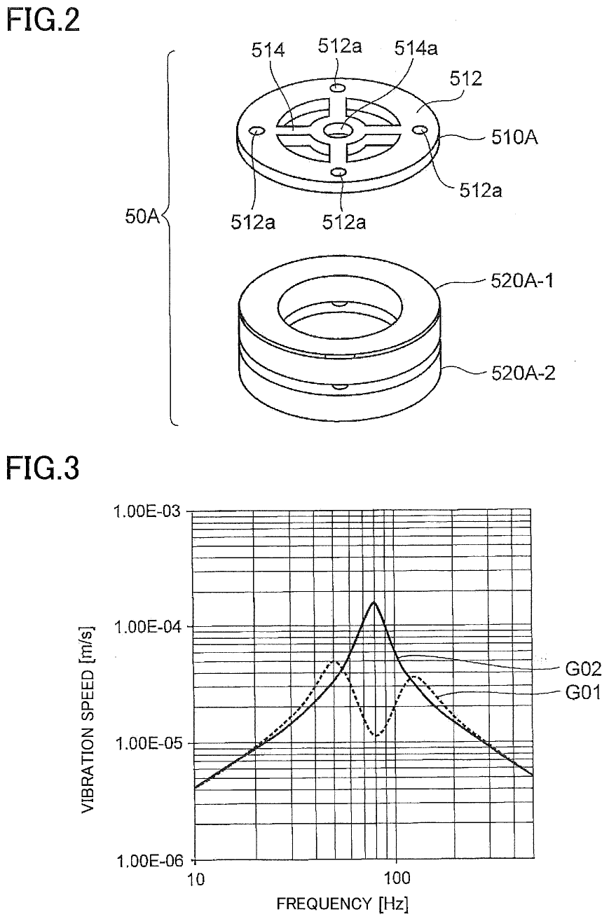

FIG. 2 is an exploded perspective view of the dynamic vibration absorber 50A. The elastic member 510A is a flat disc-like member formed of a material having viscoelasticity such as fluororubber. It is noted that the material of the elastic member 510A is not limited to a material having viscoelasticity and at least needs to be a material having elasticity such as resin. The elastic member 510A includes: a weight-member holder 512 shaped like a ring; and the coupling member 514 shaped like a cross and provided on an inner circumferential side of the weight-member holder 512. A hole 514a is formed in the center of the coupling member 514. The screw 210 is to be inserted in the hole 514a. The weight-member holder 512 has four holes 512a equally spaced apart from each other in the circumferential direction. In the microphone 1 according to the present embodiment, as illustrated in FIG. 1, the screw 210 is inserted in a nut 60-1, a washer 70-1, the hole 514a of the coupling member 514, a washer 70-2, and a nut 60-2, and the nuts 60-1, 60-2 are tightened, whereby the elastic member 510A is mounted to the microphone unit 20. That is, the elastic member 510A is mounted to the microphone unit 20 at a portion of the elastic member 510A around the hole 514a. The portion of the elastic member 510A around the hole 514a is a portion of the disc-like elastic member 510A near its center. For example, this portion is a portion of the disc-like elastic member 510A sandwiched between the nuts 60-1, 60-2 and the washers 70-1, 70-2 vertically in the up and down direction (noted that this portion may be hereinafter referred to as “near-center portion”). The weight members 520A-1, 520A-2 are held by the weight-member holder 512 located at a distance from the near-center portion. A portion (e.g., the coupling member 514) of the elastic member 510A between the near-center portion mounted to the microphone unit 20 and the weight-member holder 512 holding the weight members 520A-1, 520A-2 is elastically deformed to vibrate the weight members 520A-1, 520A-2 and the microphone unit 20 respectively in opposite phases. Since the center of an elastically deformable portion of the elastic member 510A is located at the same position as the center of the disc-like elastic member 510A, a direction in which the weight members 520A-1, 520A-2 vibrate in the reverse phase coincides with the central axis of the microphone 1 (the central axis of the housing 10). This configuration reduces handling noise well.

The washer 70-1 and the washer 70-2 are annular members having the same size and formed of metal having difficulty in deformation, such as stainless steel, for example. In the following description, each of the washer 70-1 and the washer 70-2 may be referred to as “washer 70” in the case where there is no need of distinction between the washer 70-1 and the washer 70-2. As illustrated in FIG. 1, the width of an annular portion of the washer 70 (i.e., the length of the annular portion in the radial direction) is less than the length of the coupling member 514 in the radial direction, and only a portion of the coupling member 514 which is not located between the washer 70-1 and the washer 70-2 in the dynamic vibration absorber 50A serves as a spring of the spring-mass system. Since the washer 70 is formed of metal having difficulty in deformation as described above, shear deformation of a portion of the coupling member 514 which is located between the washer 70-1 and the washer 70-2 is inhibited by the washer 70-1 and the washer 70-2.

In the case where the elastic member 510A is mounted on the screw 210 using a washer having a larger width at its annular portion instead of the washer 70, the spring constant in the spring-mass system is smaller than that in the present embodiment, and the resonant frequency of the dynamic vibration absorber 50A is lower than that in the present embodiment. In contrast, in the case where the elastic member 510A is mounted on the screw 210 using a washer having a smaller width at its annular portion instead of the washer 70, the spring constant in the spring-mass system is greater than that in the present embodiment, and the resonant frequency of the dynamic vibration absorber 50A is higher than that in the present embodiment. That is, the washer 70 in the microphone 1 serves as an adjusting member that adjusts the elasticity of the elastic member 510A to adjust the resonant frequency of the dynamic vibration absorber 50A. In the microphone 1 according to the present embodiment, since the resonant frequency of the dynamic vibration absorber 50A can be adjusted by selecting the washer 70, it is possible to finely deal with vibrations of the microphone unit 20 in accordance with the frequency of handling noise to be reduced.

Each of the weight members 520A-1, 520A-2 is a ring-like member formed of metal having high stiffness, such as aluminum. The reason why each of the weight members 520A-1, 520A-2 is formed of metal in the present embodiment is that each of the weight members 520A-1, 520A-2 needs to have some weight, and an occurrence of a resonance in the weight member itself is not preferable. However, each of the weight members 520A-1, 520A-2 may be formed of any material as long as each of the weight members 520A-1, 520A-2 has some weight, and a resonance in the weight member itself does not occur.

Four protruding portions 522 (see FIG. 1) are provided on a bottom surface of the weight member 520A-1. The protruding portions 522 correspond respectively to the four holes 512a. A flat surface of the weight member 520A-2 has four holes 524 corresponding respectively to the four protruding portions 522. In the state in which the weight member 520A-1 is mounted on the elastic member 510A, a distal end of each of the protruding portions 522 protrudes downward from a corresponding one of the holes 512a formed in the elastic member 510A. The weight members 520A-1, 520A-2 are mounted on the elastic member 510A by fitting the protruding portions 522 into the respective holes 524, with the elastic member 510A interposed between the weight members 520A-1, 520A-2.

The mass (the weight) of each of the weight members 520A-1, 520A-2 is set such that the center of gravity of a system constituted by the microphone unit 20, the elastic member 510A, and the weight members 520A-1, 520A-2 (noted that this center may be hereinafter referred to simply as “the center of gravity of the system”) is located at a height position of the first end face of the insulator 30 in the vertical direction. This configuration improves stability when the insulator 30 supports the system constituted by the microphone unit 20, the elastic member 510A, and the weight members 520A-1, 520A-2. As described above, the insulator 30 supports the microphone unit 20 by the first end face that is one of the end faces of the insulator 30 which has a radius less than that of the other, at a position at which the insulator 30 and the microphone unit 20 are in contact with each other. Thus, it is possible for the insulator 30 to stably support the microphone unit 20 by making the center of gravity of the system in the vertical direction coincide with the position of the first end face of the insulator 30 in the vertical direction. Accordingly, in the case where the microphone unit 20, for example, is supported by the insulator 30 at a first position which is located between the top face and the bottom face of the microphone unit 20 in the vertical direction and at which the insulator 30 and the microphone unit 20 are in contact with each other, the masses of the weight members 520A-1, 520A-2 are preferably determined such that the center of gravity of the system substantially coincides with the first position in the vertical direction.

FIG. 3 is a view for explaining the effects of the present embodiment. FIG. 3 illustrates graphs each representing a relationship between a vibration speed and a frequency of an evaluation surface for a corresponding one of the microphone 1 according to the present embodiment and a microphone for comparison which is configured by removing the dynamic vibration absorber 50A from the microphone 1, in the case where an upper surface SL of the microphone unit 20 (see FIG. 1) is set as the evaluation surface. The microphone for comparison is a conventional handheld microphone not including the dynamic vibration absorber 50A.

The vertical axis in FIG. 3 is a coordinate axis representing a common logarithm value of the vibration speed of the evaluation surface in the case where the upper surface SL of the microphone unit 20 (see FIG. 1) is set as the evaluation surface. The horizontal axis in FIG. 3 is a coordinate axis representing a common logarithm value of the frequency. The graph G01 in FIG. 3 represents a relationship between the vibration speed and the frequency of the evaluation surface in the microphone 1. The graph G02 in FIG. 3 represents a relationship between the vibration speed and the frequency of the evaluation surface in the microphone for comparison.

As is obvious when the graph G01 and the graph G02 in FIG. 3 are compared with each other, the vibration speed in a frequency range around 80 Hz is considerably less in the microphone 1 according to the present embodiment than in the microphone for comparison. Thus, even in the case where the peak of the graph G02 in the frequency range around 80 Hz is a peak that cannot be sufficiently shifted to the lower limit in an audible frequency range in conventional techniques, the microphone 1 according to the present embodiment can lower the peak to reduce handling noise corresponding to the peak.

Since the microphone 1 according to the present embodiment can lower the resonance peak that cannot be sufficiently shifted to a frequency lower than the lower limit in the audible frequency range in the conventional techniques, there is no need for the insulator 30 to hold the microphone unit 20 by a smaller force in order to reduce handling noise. Accordingly, in the microphone 1 according to the present embodiment, there is no need for the insulator 30 to hold the microphone unit 20 by a smaller force in order to reduce handling noise, thereby ensuring the quality of a product.

Thus, the microphone 1 according to the present embodiment can ensure the quality of the product and reduce handling noise when compared with conventional microphones.

While the embodiment has been described above, it is to be understood that the disclosure is not limited to the details of the illustrated embodiment, but may be embodied with various changes and modifications, which may occur to those skilled in the art, without departing from the spirit and scope of the disclosure.

### First Modification

While the microphone 1 according to the above-described embodiment includes the washer 70 as the adjusting member that adjusts the elasticity of the elastic member 510A, the adjusting member may be omitted. That is, the microphone according to the present disclosure at least needs to include: a housing; a microphone unit provided in the housing; an elastic member mounted to the microphone unit; and a weight member mounted to the elastic member. While the elastic member 510A is mounted to the microphone unit 20 with the screw 210 in the above-described embodiment, an extending portion (including the screw 210 in one embodiment) extending from the bottom surface of the microphone unit 20 may be secured to the elastic member 510A with, e.g., adhesive to mount the elastic member 510A to the microphone unit 20. In the case where the elastic member 510A is mounted in this manner, it is preferable that the extending portion is secured to the portion of the disc-like elastic member 510A near its center (the near-center portion), and a portion of the elastic member 510A which is located at a distance from the near-center portion is formed as the weight-member holder 512. With this configuration, the portion of the elastic member 510A which is located between the weight-member holder 512 and the near-center portion of the elastic member 510A is elastically deformable, making it possible to reduce handling noise. As long as handling noise is reduced, the weight-member holder 512 may have any shape other than the ring-shape. Likewise, as long as handling noise is reduced, each of the weight members 520A-1, 520A-2 may have any shape other than the ring-shape. The coupling member 514 may have any shape other than the cross-shape.

### Second Modification

In the microphone 1 according to the above-described embodiment, the mass (the weight) of each of the weight members 520A-1, 520A-2 is set such that the center of gravity of the system constituted by the microphone unit 20, the elastic member 510A, and the weight members 520A-1, 520A-2 is located at the position on the first end face of the insulator 30 (i.e., a position of the point of action of a force for supporting the system in the vertical direction). However, the mass of each of the weight members 520A-1, 520A-2 may be set in accordance with a relationship with the resonance peak to be reduced, independently of the position of the center of gravity. In a modification in which the adjusting member is omitted like the first modification, the resonant frequency of the dynamic vibration absorber 50A is determined in accordance with the mass of each of the weight members 520A-1, 520A-2. Accordingly, in the modification in which the adjusting member is omitted, the mass of each of the weight members 520A-1, 520A-2 at least needs to be determined independently of the position of the center of gravity, such that the frequency at the resonance peak to be lowered and the resonant frequency of the dynamic vibration absorber 50A coincide with each other.

### Third Modification

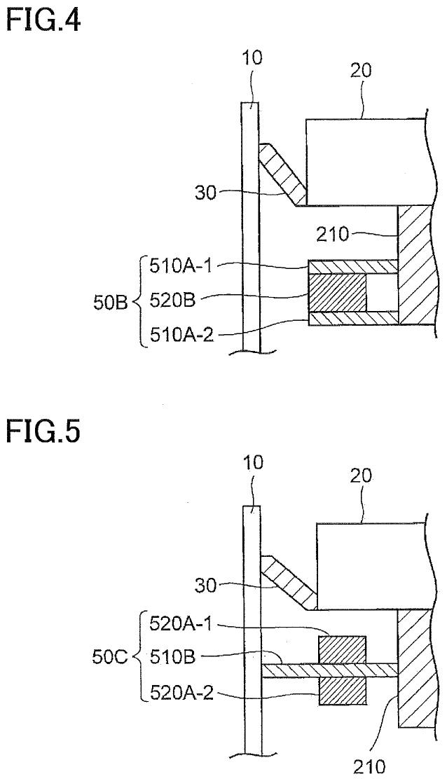

The dynamic vibration absorber 50A in the above-described embodiment includes: the elastic member 510A mounted on the screw 210 extending downward from the bottom surface of the microphone unit 20; and the weight members 520A-1, 520A-2 mounted on the elastic member 510A so as to hold the elastic member 510A between the weight members 520A-1, 520A-2. In a third modification, as illustrated in FIG. 4, the dynamic vibration absorber 50A is replaced with a dynamic vibration absorber 50B that includes: elastic members 510A-1, 510A-2 mounted on the screw 210; and a weight member 520B held by and between the elastic members 510A-1, 510A-2. It is noted that FIG. 4 omits illustration of nuts for securing the elastic member to the screw 210 and illustration of a windshield (noted that these illustrations are omitted also in FIG. 5). Though not illustrated in FIG. 4 in detail, the weight member 520B is a ring-like member formed of, e.g., metal like the weight member 520A-1 in the above-described embodiment. The weight member 520B is different from the weight member 520A-1 in that the protruding portions 522 are provided on both of an upper surface and a bottom surface of the weight member 520B.

### Fourth Modifications

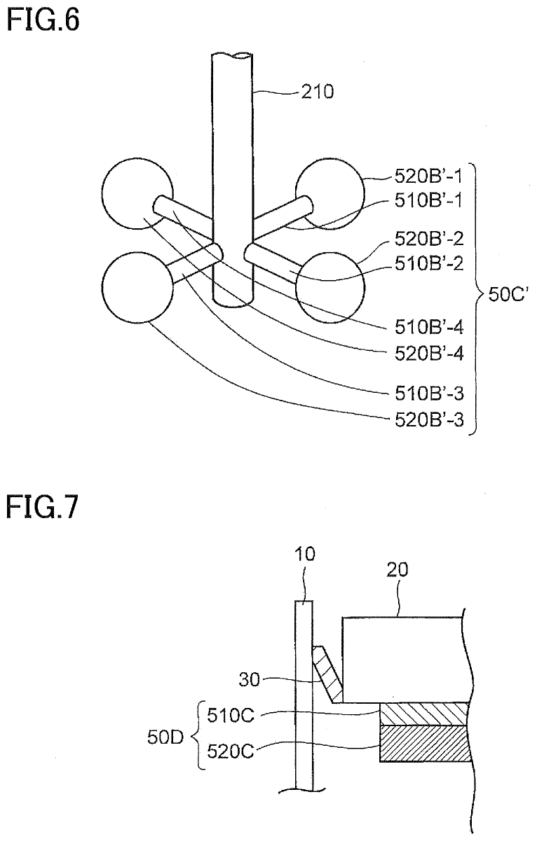

The elastic member 510A of the dynamic vibration absorber 50A in the above-described embodiment is shaped like a disc having a diameter that is less than the inside diameter of the housing 10. As illustrated in FIG. 5, however, a microphone according to a modification may include a dynamic vibration absorber 50C including an elastic member 510B instead of the elastic member 510A. The elastic member 510B is shaped like a disc having a diameter that is substantially equal to the inside diameter of the housing 10. Thus, in the microphone using the dynamic vibration absorber 50C, the outer periphery of the elastic member 510B is in contact with the inner circumferential surface of the housing 10 as one example of an inner wall. This configuration reduces rotational vibrations of the microphone unit 20 in a circumferential direction centered about the axis of the housing 10, thereby reducing handling noise caused by the rotational vibrations. As illustrated in FIG. 6, the dynamic vibration absorber 50C may be replaced with a dynamic vibration absorber 50C′ including: elastic members 510B′-1, 510B′-2, 510B′-3, 510B′-4 each shaped like a rod and each extending in a direction intersecting the screw 210 and secured at its one end to the screw 210; and weight members 520B′-1, 520B′-2, 520B′-3, 520B′-4 mounted respectively on the other ends of the respective elastic members 510B′-1, 510B′-2, 510B′-3, 510B′-4. This configuration achieves the same effects as achieved by the dynamic vibration absorber 50C, by adjusting the lengths of the respective elastic members 510B′-1, 510B′-2, 510B′-3, 510B′-4 such that the weight members 520B′-1, 520B′-2, 520B′-3, 520B′-4 are in contact with the inner circumferential surface of the housing 10.

### Fifth Modifications

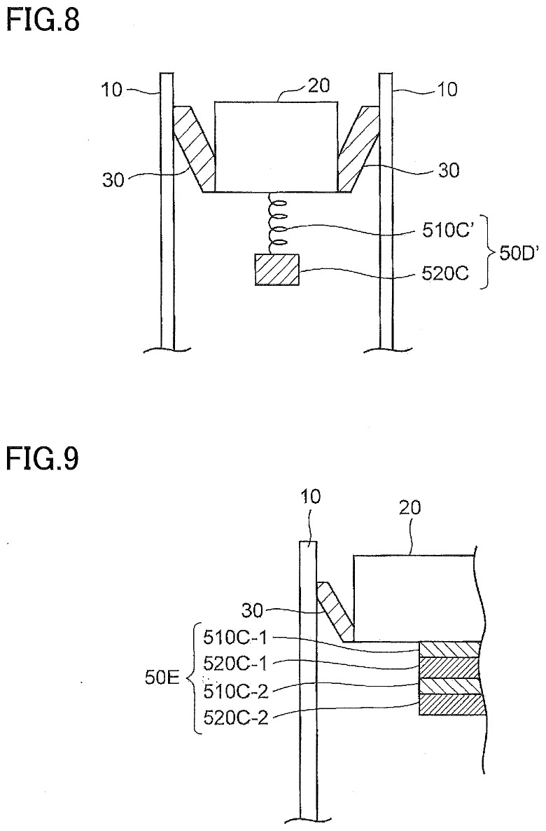

In the microphone 1 according to the above-described embodiment, the dynamic vibration absorber 50A is mounted on the screw 210 extending from the bottom surface of the microphone unit 20. As illustrated in FIG. 7, however, a microphone according to a modification may include a dynamic vibration absorber 50D including: an elastic member 510C shaped like a disc and mounted at one (as one example of a first surface) of its opposite surfaces on the bottom surface of the microphone unit 20; and a weight member 520C mounted on the other surface (as one example of a second surface) of the elastic member 510C. As illustrated in FIG. 8, a microphone according to a modification may include a dynamic vibration absorber 50D′ including: an elastic member 510C′ formed of resin or metal and shaped like a spiral spring mounted at its one end (as one example of a first end) on the bottom surface of the microphone unit 20; and the weight member 520C mounted on the other end (as one example of a second end) of the elastic member 510C′. It is noted that an adhesive may be used for mounting of the elastic member 510C (or the elastic member 510C′) on the microphone unit 20 and mounting of the weight member 520C on the elastic member 510C (or the elastic member 510C′), for example.

### Sixth Modifications

The microphone 1 according to the above-described embodiment includes only one pair of the elastic member mounted to the microphone unit and the weight member mounted on the elastic member. However, a microphone according to a modification may include at least one elastic member mounted to the microphone unit and at least one weight member mounted on the at least one elastic member. For example, the microphone may include a plurality of pairs of the elastic members and the weight members. Such a microphone can deal with a plurality of frequencies of handling noise. For example, in the case where N pairs of the elastic members and the weight members are provided, it is possible to reduce handling noise of up to N+1 types.

For example, FIG. 9 illustrates a microphone including a dynamic vibration absorber 50E that includes: an elastic member 510C-1 shaped like a disc and mounted at one of its opposite surfaces on the bottom surface of the microphone unit 20; a weight member 520C-1 having a mass m1 and mounted on the other surface of the elastic member 510C-1; an elastic member 510C-2 shaped like a disc and mounted at one of its opposite surfaces on the weight member 520C-1; and a weight member 520C-2 having a mass m2 and mounted on the other surface of the elastic member 510C-2. The mass m2 is not equal to the mass m1. This microphone can lower the resonance peak of the frequency related to the mass m1, the resonance peak of the frequency related to the mass m2, and the resonance peak of the frequency related to the sum of the mass m1 and the mass m2.

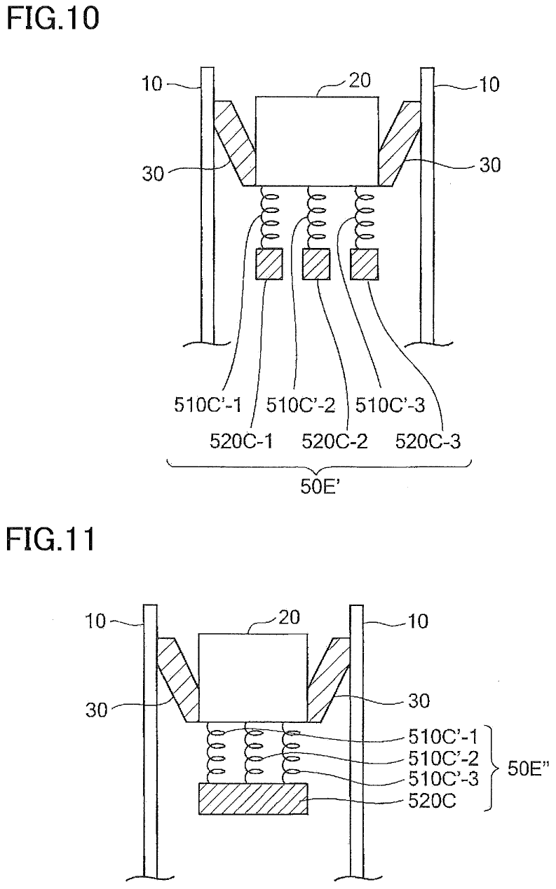

As illustrated in FIG. 10, the dynamic vibration absorber 50E may be replaced with a dynamic vibration absorber 50E′ including: an elastic member 510C′-1, an elastic member 510C′-2, and an elastic member 510C′-3 each formed of resin or metal and each shaped like a spiral spring mounted at its one end on the bottom surface of the microphone unit 20; a weight member 520C-1 mounted on the other end of the elastic member 510C′-1; a weight member 520C-2 mounted on the other end of the elastic member 510C′-2; and a weight member 520C-3 mounted on the other end of the elastic member 510C′-3. As illustrated in FIG. 11, the dynamic vibration absorber 50E may be replaced with a dynamic vibration absorber 50E″ including: the elastic member 510C′-1, the elastic member 510C′-2, and the elastic member 510C′-3 each mounted at one end on the microphone unit 20; and the weight member 520C mounted on the other ends of the respective elastic member 510C′-1, 510C′-2, 510C′-3.

What is claimed is:

1. A microphone comprising:
a housing;
a microphone unit that outputs a sound signal disposed in the housing;
an elastic member mounted to the microphone unit; and
a weight member mounted to the elastic member.

2. The microphone according to claim 1, further comprising an insulator supporting the microphone unit with respect to the housing and in contact with the housing at a predetermined position in a vertical direction,
wherein a weight of the weight member is determined to allow a center of gravity of a system constituted by the microphone unit, the elastic member, and the weight member to be located at the predetermined position.

3. The microphone according to claim 1, further comprising an adjusting member configured to adjust elasticity of the elastic member.

4. The microphone according to claim 1, further comprising a plurality of pairs of ones of the elastic member and a plurality of ones of the weight member.

5. The microphone according to claim 1, wherein the elastic member:
has a disc shape,
is mounted to the microphone unit at a portion of the elastic member located in a vicinity of a center of the disc shape of the elastic member, and
holds the weight member at a distance from the portion of the elastic member located in the vicinity of the center.

6. The microphone according to claim 5, further comprising:
an extending member extending from a bottom surface of the microphone unit,
wherein the portion of the elastic member located in the vicinity of the center is secured to the extending member to mount the elastic member to the microphone unit.

7. The microphone according to claim 6, wherein the portion of the elastic member located in the vicinity of the center includes a hole through which the extending member extends.

8. The microphone according to claim 7, wherein:
the extending member is a screw, and
the portion of the elastic member located in the vicinity of the center is held between a pair of nuts secured to the screw and between a pair of washers inserted in the screw, with the screw inserted in the hole, to mount the elastic member to the microphone unit.

9. The microphone according to claim 5, wherein the weight member has a ring shape disposed at a distance from the portion of the elastic member located in the vicinity of the center.

10. The microphone according to claim 5, wherein:
the weight member has a ring shape, and
the elastic member includes:
a weight-member holder having a ring shape configured to hold the weight member; and
a coupling member having a cross shape and provided on an inner circumferential side of the weight-member holder.

11. The microphone according to claim 10, further comprising:
an extending member extending from a bottom surface of the microphone unit,
wherein the coupling member at a center thereof includes a hole through which the extending member is inserted.

12. The microphone according to claim 11, wherein:
the extending member is a screw, and
a portion of the coupling member of the elastic member located in the vicinity of the center is held between a pair of nuts secured to the screw and between a pair of washers inserted in the screw, with the screw inserted in the hole, to mount the elastic member to the microphone unit.

13. The microphone according to claim 1, wherein one of the elastic member or the weight member is in contact with an inner wall of the housing.

14. The microphone according to claim 1, wherein:
the elastic member has a disc shape, and
a first surface of the elastic member is mounted on a bottom surface of the microphone unit, and the weight member is mounted on a second surface of the elastic member.

15. The microphone according to claim 1, wherein:
the elastic member is a coil spring, and
a first end of the coil spring is attached to a bottom surface of the microphone unit, and a second end of the coil spring is attached to the weight member.
